(19) United States
(12) Patent Application Publication
(10) Pub. No.: US 2019/0139452 A1
(43) Pub. Date: May 9, 2019

(54) SIMULATION MANIKIN FOR CANNULATION

(71) Applicant: BARTS HEALTH NHS TRUST, London (GB)

(72) Inventors: Megan HALL-JACKSON, Epping Essex (GB); Rebecca PREEDY, London (GB); Stephen PARKS, London (GB)

(73) Assignee: Barts Health NHS Trust, London (GB)

(21) Appl. No.: 16/095,418

(22) PCT Filed: Apr. 20, 2017
(86) PCT No.: PCT/EP2017/059444

§ 371 Date: Oct. 22, 2018

(30) Foreign Application Priority Data
Apr. 22, 2016 (GB) 1607072.4

(51) Int. Cl. G09B 23/28; G09B 23/30

(52) U.S. Cl. CPC G09B 23/285; G09B 23/30

(57) ABSTRACT

A simulation manikin (1) for central venous cannulation comprises a first tube (3) for simulating a vein, a simulated clavicle (4), a first member (2) to which the tube (3) and simulated clavicle (4) are removeably affixed to in a position which is anatomically correct with respect to each other and a second member (11) having a surface which simulates the contours of half a neck to the clavicle. The manikin (1) is useful for teaching students identification of key anatomic landmarks, navigation of needle under ultrasound, recognition of correct blood vessels, and avoiding and managing potential complications.

### FIELD OF THE INVENTION

This invention relates to a simulation manikin for central venous cannulation. It is useful for teaching students identification of key anatomic landmarks, navigation of needle under ultrasound, recognition of correct blood vessels, and avoiding and managing potential complications. The invention also relates to a method for production of the manikin, and a method for teaching students which comprises providing the manikin.

### BACKGROUND OF THE INVENTION

Medical doctors are trained to carry out central venous cannulation (CVC) using models. These models typically include a manikin of the neck and top of a human torso. The known models can be used to provide the required training, but they suffer from a number of drawbacks.

For example, one of the models generally used is supplied by Limbs and Things. It includes a manikin that can be used for training, but suffers from the problem that it is large and bulky. In addition, it is not possible to insert a needle into the part of the model that ultrasound can be applied to. Blocks in the neck of the model must be replaced to enable separate use of ultrasound, and catheter insertion. At more than £1000, the model is expensive to buy and replacement parts for this model are also expensive.

A second model is supplied by Adam Rouilly. At a cost approaching £1000 it is also expensive to buy and it is bulky and heavy. It cannot be used for simultaneous ultrasound and cannula insertion. The vessels in the model can only be used for paediatric gauge cannulas, which is not considered to be a reasonable replacement for training. The simulated skin of the model wears out after repeated needle insertion and ideally should be replaced after about 10 punctures. The simulated veins should be replaced when using adult needles after only about 3 punctures. The cost for these replacement parts is significant.

A newer model by Adam Rouilly is also available which addresses some of these problems. However, at a cost of more than £1500, it is expensive. In addition, it is not possible to carry out real time ultrasound at the same time as inserting a cannula. Furthermore, the cannula size must remain very small and the material of the simulated skin and veins will be destroyed by use (after about 20 punctures) and the cost for replacement parts is significant.

Finally, a further alternative model is supplied by Pharmabotics. It can be used for training in the use of ultrasound but the tissue of the simulated skin and veins breaks up after about 15 uses. The cost is more than £1000 and the cost for replacement parts is significant.

The known models all suffer from the drawbacks that they are bulky, they have a high cost, wear out quickly and replacement parts are expensive. This means that the number of models per student is likely to be limited and the number of practice attempts made by each student is also likely to be limited.

Accordingly, there is a need for an alternative or improved model that acts effectively as a manikin for CVC, is less bulky and is produced at reduced cost.

The present invention seeks to provide an alternative or improvement which preferably addresses one or more of the problems presented by prior art arrangements.

### SUMMARY OF THE INVENTION

The manikin of the present invention employs a two part jelly mould. One half is the contours of half a neck to the clavicle. The other half holds the vessels and clavicle. The manikin is lined with gauze which gives a realistic skin puncture sensation, put the two parts of the mould together, and fill with gelatine. Advantageously, the manikin feels solid like flesh, has a good resistance to a needle, is perfect for ultrasound and for approximately 5 punctures will re-seal. Remarkably, this allows production of a manikin with technical advantages as will be detailed below.

The present invention is directed to providing a simulation manikin for teaching and practising central venous cannulation.

In accordance with a first aspect, the present invention provides a simulation manikin for central venous cannulation which comprises a first tube for simulating a vein, a simulated clavicle, a first member to which the tube and simulated clavicle are removeably affixed to in a position which is anatomically correct with respect to each other and a second member having a surface which simulates the contours of half a neck to the clavicle.

Preferably, the simulated clavicle has the shape and configuration of a human clavicle. In one embodiment, the simulated clavicle has the shape and configuration of an adult clavicle. In a further embodiment, the simulated clavicle has the shape and configuration of a child's clavicle. Preferably, the simulated clavicle is formed of plastics or polymer material. Preferably, it has the density of human bone.

Preferably the tube is manufactured of self-sealing material. Preferably it is manufactured of rubber or polymer. Advantageously, the tube can be pierced with a cannula needle and when the needle is removed, the tube reseals so that it does not leak. Preferably, the tube has the shape and configuration of a human vein. In particular, preferably, the thickness of the tube is anatomically correct relative to a human central vein.

Preferably, a liquid is placed in the tube. Preferably, the liquid is a blood simulant or the liquid simulates blood.

Preferably, the first member is substantially planar. In one embodiment it forms a lid which can be adjoined to a container formed by the second member. Preferably, the first member comprises at least one flange adjoined to the first member by at least one hinge. Preferably, the flange provides a means for removeably attaching the first member to the second member. In a preferred embodiment, the means for removeably attaching the first member to the second member comprises a slot defined in the flange and a projection in the second member engages in the slot with a tight snap fit.

Preferably, the first member is substantially rectangular and four flanges are provided at each edge of the first member, each adjoined to the first member by a hinge. Preferably, each flange provides a means for removeably attaching the first member to the second member. In a preferred embodiment, two opposing flanges define two slots and two projections are provided in the second member which engages in the slots with a tight snap fit. In addition, two opposing flanges define single slots and single projections are provided in the second member which engage in the slots with a tight snap fit.

Advantageously, the means for removeably attaching the first member to the second member allow the members to form two parts of a mould that can be easily joined or separated.

Preferably, the first member is produced in a variety of colours. This enables easy identification.

Preferably, a clamp is provided at each opposing end of the first member for holding the tube in position. Preferably, each clamp comprises a flange which is hinged to a projection in the surface of the first member. The tube is gripped by each clamp by squashing the tube between the flange and the projection. Preferably, each flange of each clamp has at least one rib which grips the tube. Preferably, at least two ribs are provided. Preferably, no ribs are provided at the front, opening end of the clamps so that the clamps flex more easily and so that they can be easily unclipped.

Preferably, a groove is provided in the surface of the first member for griping the simulated clavicle. Preferably, the simulated clavicle has a tight snap fit in the groove.

Preferably, the second member is substantially forms a container which mates with the lid formed by the first member. Preferably, the second member is manufactured of colourless or opaque material. Advantageously, this enables a user to see through the second member.

Preferably, an opening is defined in the base of the second member. Advantageously, the tube can be inserted though this opening and a length of the tube can be stored in the base of the second member.

Preferably, a frame defining a grid of channels is provided in the base of the second member. Advantageously, the tube can be wound around the frame.

Preferably, the frame is arranged to provide at least one void for measuring a liquid volume of about 60 mls.

Preferably, in use a chamber is defined between the first member and the second member and the tube and simulated clavicle are positioned in the chamber and held in anatomically correct position relative to each other.

Preferably, the first member and the second member together form two separable parts of a jelly mould. Preferably, the first member is in the form of a lid which can be used to close an open container formed by the second member.

Preferably, a sealable opening is defined in the first member or the second member through which liquid gelatine can be poured. Preferably, the sealable opening is defined in the second member.

Preferably, a plug is provided for sealing the sealable opening. Preferably, the plug is of silicone. In one embodiment, the plug is retained in the opening. This provides the advantage that the plug is not easily lost.

Preferably, in use, the tube and the simulated clavicle are placed in position on the first member. The first member and the second member are adjoined thereby providing a chamber between the first member and the second member. Liquid gelatine is poured through the opening into the chamber defined between the first member and the second member. Thereafter, the opening is preferably sealed and the liquid gelatine is cooled to set it in the chamber. After the gelatine has set, the first member and the second member are separated to reveal a first member having set gelatine formed thereon, wherein the gelatine has a surface which simulates the contours of half a neck to the clavicle. Within the set gelatine the tube and simulated clavicle are in a position which is anatomically correct with respect to each other and the surface of the gelatine.

Preferably, the set gelatine is lined with gauze. The gauze is preferably applied to the surface of the second member which simulates the contours of half a neck to the clavicle prior to filling the chamber with gelatine; or it is applied to the set gelatine. Advantageously, the gauze and gelatine simulate flesh covered by skin and when punctured with a needle it provides a realistic skin puncture sensation.

Preferably, the manikin additionally comprises a second tube to simulate an artery. Preferably, it is removeably affixed to the first member and held in an anatomically correct position relative to the simulated clavicle and the first tube which simulates a vein.

Preferably the second tube is manufactured of self-sealing material. Preferably it is manufactured of rubber or polymer. Advantageously, the second tube can be pierced with a cannula needle and when the needle is removed, the tube reseals so that it does not leak. Preferably, the second tube has the shape and configuration of a human artery. In particular, preferably, the thickness of the tube is anatomically correct relative to a human central artery.

A manikin in accordance with the invention has surprisingly been found to produce a particularly high quality model for teaching students. Advantageously, the manikin of the invention can be produced at very low cost compared to known manikins. This means that large numbers of manikins can be provided so there is a low student to manikin ratio.

Advantageously, ultrasound can be used to view and assess cannula insertion. In this regard, in contrast to many known manikins, ultrasound and cannula insertion can be carried out simultaneously.

Advantageously, the manikin of the invention is anatomically correct and anatomic markers are provided. Furthermore, after use, the manikin of the invention can be refurbished in any location having a fridge and a kettle.

In addition, the manikin of the invention is easy to store, with no extraneous parts and no unnecessary bulk.

The invention provides the advantage of a realistic model for teaching cannulation and the insertion of central venous catheters into the superior vena cava, with and without ultrasound guidance.

In accordance with a second aspect, the present invention provides a method for producing a manikin which comprises the steps of providing and assembling a first tube for simulating a vein, a simulated clavicle, a first member, a second member; pouring liquid gelatine into an opening defined in the first member or the second member, cooling and setting the gelatine, separating the first member and the second member.

In a further aspect, the invention provides a method for teaching students central venous cannulation, wherein the method comprises the step of employing a manikin according to the invention.

### BRIEF DESCRIPTION OF THE DRAWINGS

The invention will now be further described with reference to the accompanying drawings in which:

FIG. 1 shows a manikin of the invention, wherein the first member and the second member are adjoined;

FIG. 2 shows a manikin of the invention showing details of the second member;

FIG. 3 shows a side view of a manikin of the invention, wherein the first member and the second member are adjoined;

FIG. 4 shows various manikins of the invention showing different colour first members;

FIG. 5 shows a manikin of the invention showing an opening defined in the second member;

FIG. 6 shows a manikin of the invention showing details of the second member;

FIG. 7 shows a manikin of the invention showing details of the first member as well as the first tube, second tube and simulated clavicle; and

FIG. 8 shows a manikin of the invention showing details of the first member as well as a simulated clavicle and clamps for retaining the first tube and second tube.

### DETAILED DESCRIPTION OF THE INVENTION

It will be appreciated that aspects, embodiments and preferred features of the invention have been described herein in a way that allows the specification to be written in a clear and concise way. However, unless circumstances clearly dictate otherwise, aspects, embodiments and preferred features can be variously combined or separated in accordance with the invention. Thus, preferably, the invention provides a device having features of a combination of two or more, three or more, or four or more of the aspects described herein. In a preferred embodiment, a device in accordance with the invention comprises all aspects of the invention.

The following definitions shall apply throughout the specification and the appended claims.

Within the context of this specification, the word “about” means preferably plus or minus 20%, more preferably plus or minus 10%, even more preferably plus or minus 5%, most preferably plus or minus 2%.

Within the context of this specification, the word “comprises” means “includes, among other things” and should not be construed to mean “consists of only”.

Within the context of this specification, the word “substantially” means preferably at least 90%, more preferably 95%, even more preferably 98%, most preferably 99%.

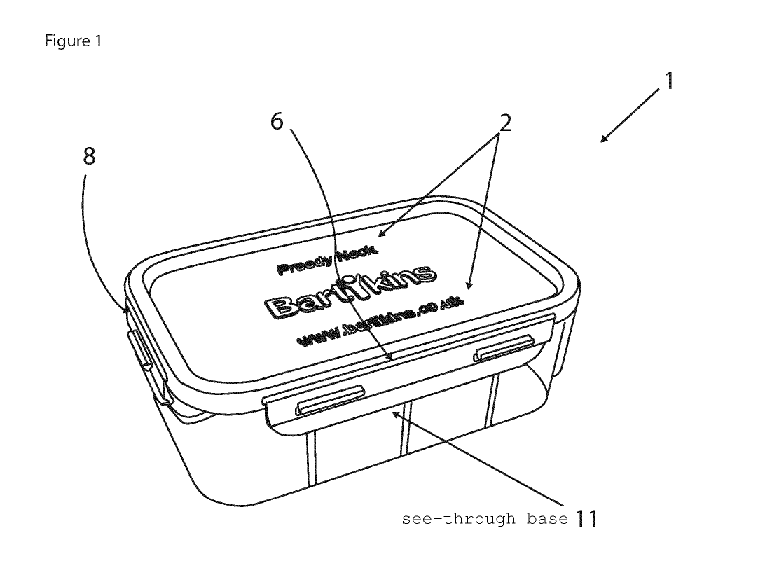

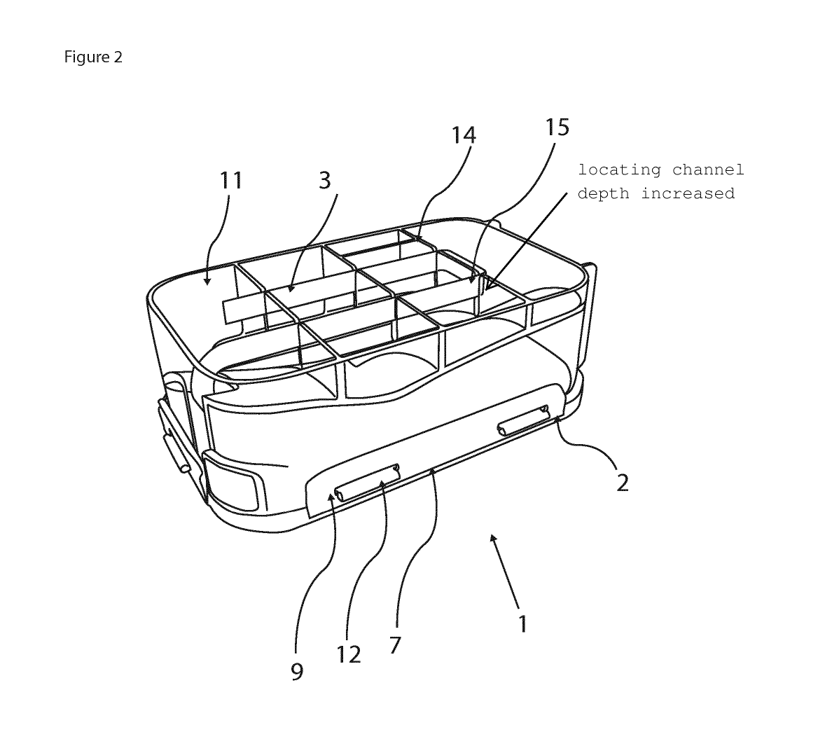

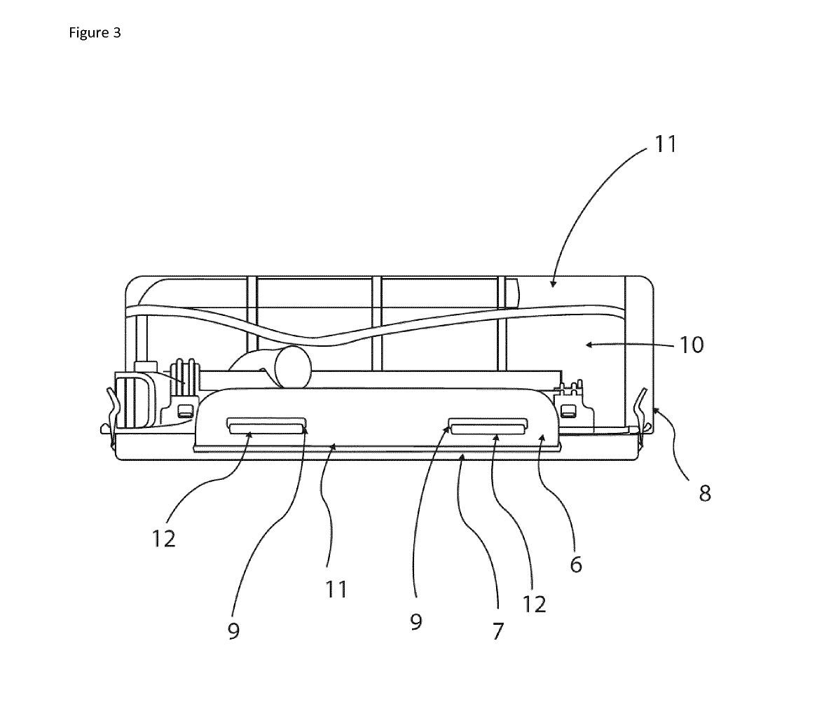

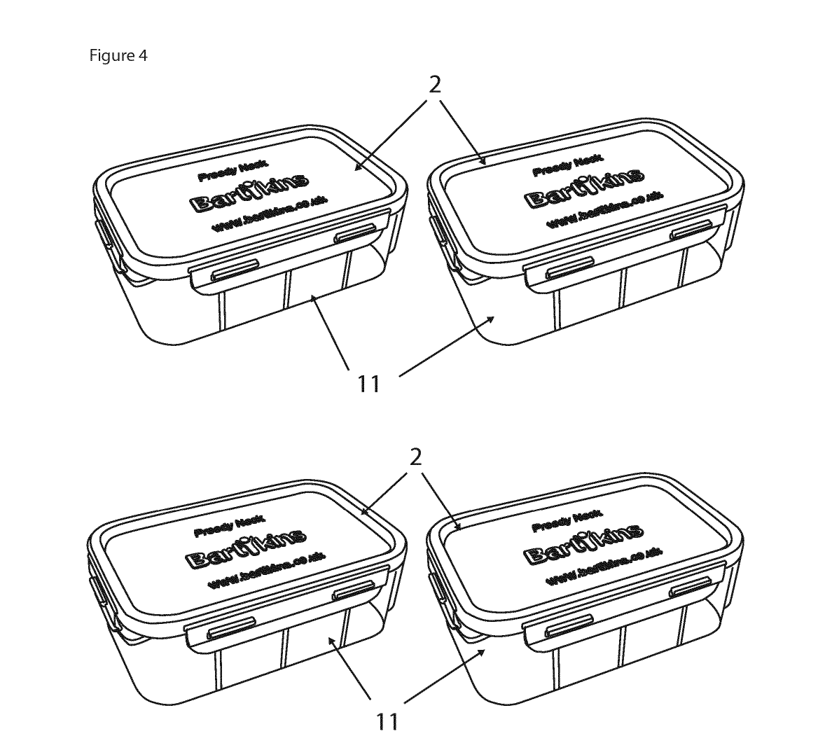

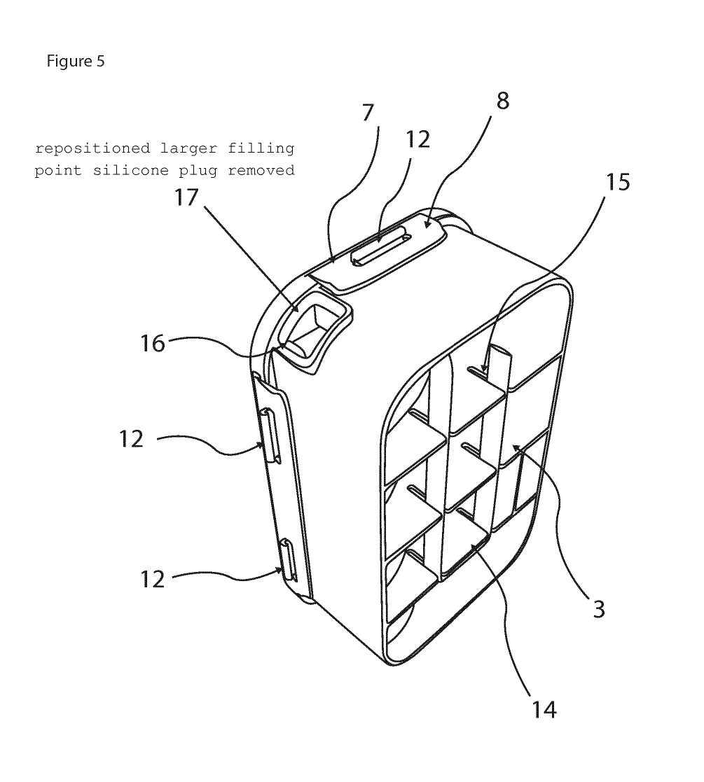

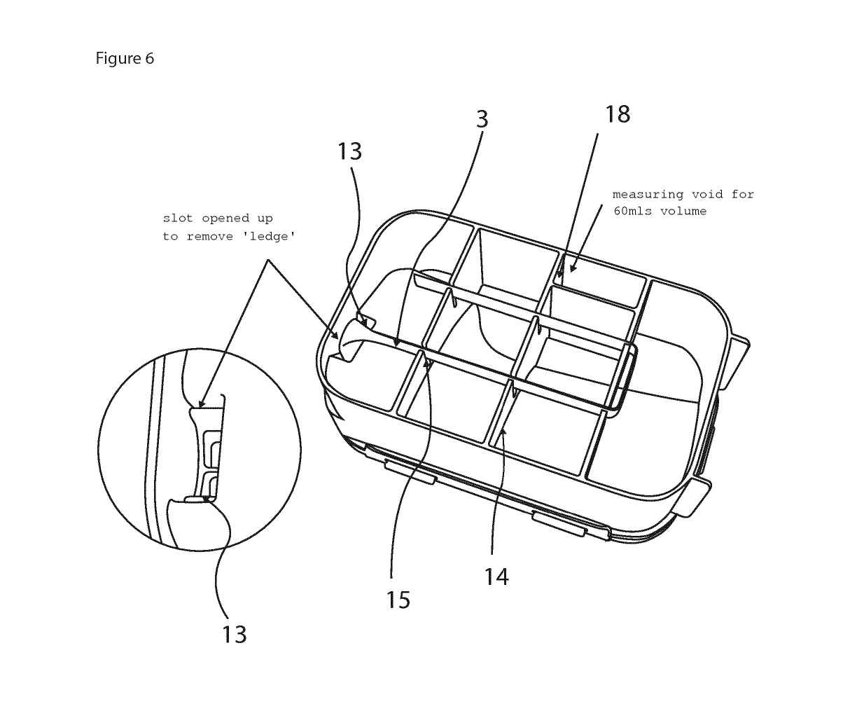

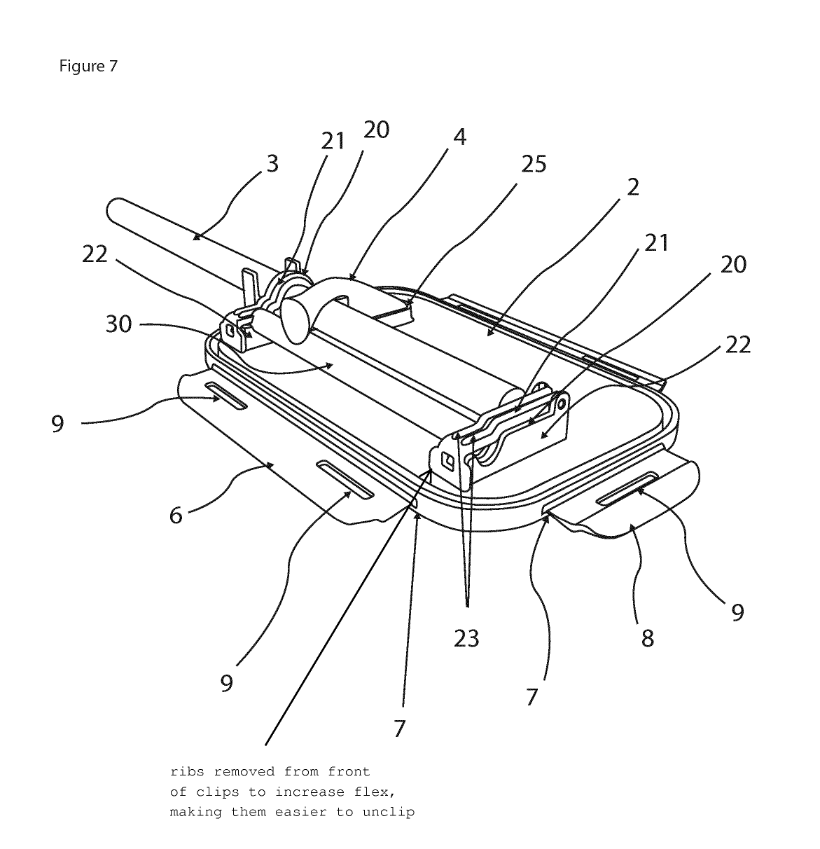

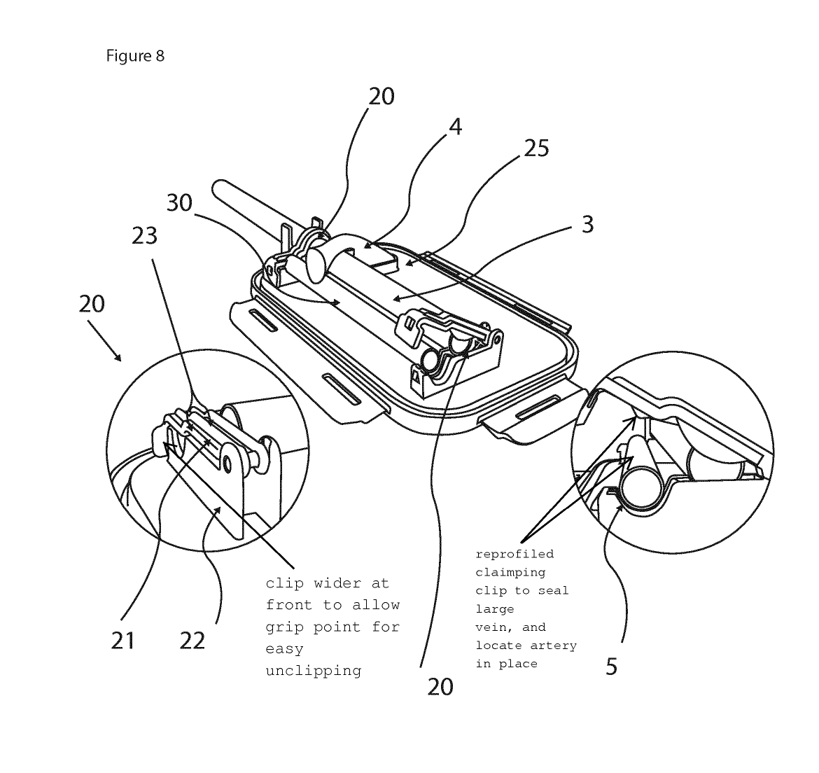

A manikin for central venous cannulation in accordance with the invention is shown in FIGS. 1 to 8.

The manikin (1) comprises a first tube (3) for simulating a vein, a simulated clavicle (4), a first member (2) to which the tube (3) and simulated clavicle (4) are removeably affixed to in a position which is anatomically correct with respect to each other and a second member (11) having a surface which simulates the contours of half a neck to the clavicle.

The simulated clavicle (4) has the shape and configuration of a human adult clavicle. The simulated clavicle (4) is formed of plastics material and has the density of human bone.

The tube (3) is manufactured of a self-sealing polymer. The tube (3) has the shape and configuration of a human vein. In particular, the thickness of the tube (3) is anatomically correct relative to a human central vein.

A liquid (5) is placed in the tube (3) to simulate blood.

The first member (2) is substantially planar. It forms a lid which can be adjoined to a container formed by the second member (11). The first member (2) is substantially rectangular and four flanges (6, 8) are provided at each edge of the first member (2), each adjoined to the first member (2) by a hinge (7). Each flange (6,8) provides a means for removeably attaching the first member (2) to the second member (11). Two opposing flanges (6) define two slots (9) and two projections (12) are provided in the second member (11) which engage in the slots (9) with a tight snap fit. In addition, two opposing flanges (8) define single slots (9) and single projections (12) are provided in the second member (11) which engage in the slots (9) with a tight snap fit.

The first member (2) is produced in a variety of colours. This enables easy identification.

A clamp (20) is provided at each opposing end of the first member for holding the tube (3) in position. Each clamp (20) comprises a flange (21) which is hinged to a projection (22) in the surface of the first member (2). The tube (3) is gripped by each clamp (20) by squashing the tube (3) between the flange (21) and the projection (22). Each flange (21) of each clamp (20) has two ribs (23) which grip the tube. No ribs (23) are provided at the front, opening end of the clamps (20) so that the clamps (20) flex more easily and so that they can be easily unclipped.

A groove (25) is provided in the surface of the first member (2) for griping the simulated clavicle (4). The simulated clavicle (4) has a tight snap fit in the groove (25).

The second member (11) substantially forms a container which mates with the lid formed by the first member (2). The second member (11) is manufactured of colourless material.

An opening (13) is defined in the base of the second member (11) through which the tube (3) can be inserted and a length of the tube (3) can be stored in the base of the second member (11).

A frame (14) defining a grid of channels (15) is provided in the base of the second member (11).

The frame (14) is arranged to provide at least one void (18) for measuring a liquid volume of about 60 mls.

In use, a chamber (10) is defined between the first member (2) and the second member (11) and the tube (3) and simulated clavicle (4) are positioned in the chamber (10) and held in anatomically correct position relative to each other.

A sealable opening (16) is defined in the second member (11) through which liquid gelatine can be poured.

A silicone plug (17) is provided for sealing the sealable opening (16).

Preferably, in use, the tube (3) and the simulated clavicle (4) are placed in position on the first member (2). The first member (2) and the second member (11) are adjoined thereby providing a chamber (10) between the first member (2) and the second member (11). Liquid gelatine is poured through the sealable opening (16) into the chamber (10). Thereafter, the opening (16) is preferably sealed with plug (17) and the liquid gelatine is cooled to set it in the chamber (10). After the gelatine has set, the first member (2) and the second member (11) are separated to reveal a first member (2) having set gelatine formed thereon, wherein the gelatine has a surface which simulates the contours of half a neck to the clavicle. Within the set gelatine the tube (3) and simulated clavicle (4) are in a position which is anatomically correct with respect to each other and the surface of the gelatine.

The set gelatine is lined with gauze (18). The gauze (18) is applied to the surface of the second member (11) which simulates the contours of half a neck to the clavicle prior to filling the chamber (10) with gelatine.

The manikin (1) additionally comprises a second tube (30) to simulate an artery. It is removeably affixed to the first member (2) and held in an anatomically correct position relative to the simulated clavicle (4) and the first tube (3) which simulates a vein.

The second tube (30) is manufactured of self-sealing polymer. The second tube (30) has the shape and configuration of a human artery. In particular, the thickness of the tube (30) is anatomically correct relative to a human central artery.

The manikin (1) provides the advantage of a model which feels solid like flesh, has a good resistance to the needle, is excellent for ultrasound, and for approximately 5 punctures will re-seal.

Once the jelly has set (about 12 hours) in the fridge it will last up to about a week in the fridge or about 24 hours out of it in a room temperature environment.

Simulated blood (5) is put into the vessels so on using the manikin the student can perform the whole procedure including drawing back blood and watching on ultrasound.

Once the tissue becomes friable and the training is finished the gelatine is broken off, the manikin is washed in hot water and can be stored neatly away for the next use.

The materials needed for the next use will be gelatine, and gauze (which are expected to cost less than about 30 pence) and on some occasions new vessels which are expected to cost no more than a few pounds.

Embodiments have been described herein in a concise way. It should be appreciated that features of these embodiments may be variously separated or combined within the invention. It will of course be understood that many variations may be made to the above-described embodiment without departing from the scope of the present invention.

1. A simulation manikin for central venous cannulation which comprises a first tube for simulating a vein, a simulated clavicle, a first member to which the tube and simulated clavicle are removeably affixed to in a position which is anatomically correct with respect to each other and a second member having a surface which simulates the contours of half a neck to the clavicle.

2. A simulation manikin according to claim 1 wherein the simulated clavicle has the shape and configuration of a human clavicle, optionally wherein the simulated clavicle has the shape and configuration of an adult clavicle or a child's clavicle.

3. (canceled)

4. A simulation manikin according to claim 1 wherein the simulated clavicle is formed of plastics or polymer material.

5. A simulation manikin according to claim 1 wherein the tube is manufactured of self-sealing material, optionally wherein the tube is manufactured of rubber or polymer.

6. (canceled)

7. A simulation manikin according to claim 1 wherein the tube has the shape and configuration of a human vein.

8. A simulation manikin according to claim 1 wherein the thickness of the tube is anatomically correct relative to a human central vein.

9. A simulation manikin according to claim 1 wherein a liquid is placed in the tube, optionally wherein the liquid is a blood simulant or the liquid simulates blood.

10. (canceled)

11. A simulation manikin according to claim 1 wherein the first member is substantially planar.

12. A simulation manikin according to claim 1 wherein the first member i) forms a lid which can be adjoined to a container formed by the second member; and/or ii) comprises at least one flange adjoined to the first member by at least one hinge.

13. (canceled)

14. A simulation manikin according to claim 12 wherein the flange provides a means for removeably attaching the first member to the second member, optionally wherein the means for removeably attaching the first member to the second member comprises a slot defined in the flange and a projection in the second member engages in the slot with a tight snap fit.

15. (canceled)

16. A simulation manikin according to claim 1 wherein the first member is substantially rectangular and four flanges are provided at each edge of the first member, each adjoined to the first member by a hinge.

17. A simulation manikin according to claim 1 wherein the first member is produced in a variety of colours.

18. A simulation manikin according to claim 1 wherein a clamp is provided at each opposing end of the first member for holding the tube in position, optionally wherein each clamp comprises a flange which is hinged to a projection in the surface of the first member and the tube is gripped by each clamp by squashing the tube between the flange and the projection.

19. (canceled)

20. A simulation manikin according to claim 18 wherein each flange of each clamp has at least one rib which grips the tube, optionally wherein no ribs are provided at the front, opening end of the clamps so that the clamps flex more easily and so that they can be easily unclipped.

21. (canceled)

22. A simulation manikin according to claim 1 wherein a groove is provided in the surface of the first member for griping the simulated clavicle.

23. A simulation manikin according to claim 1 wherein the second member substantially forms a container which mates with the lid formed by the first member.

24. A simulation manikin according to claim 1 wherein the second member is manufactured of colourless or opaque material.

25. A simulation manikin according to claim 1 wherein an opening is defined in the base of the second member.

26. A simulation manikin according to claim 1 wherein a frame defining a grid of channels is provided in the base of the second member, optionally wherein the frame is arranged to provide at least one void for measuring a liquid volume of about 60 mls.

27. (canceled)

28. A simulation manikin according to claim 1 wherein in use a chamber is defined between the first member and the second member and the tube and simulated clavicle are positioned in the chamber and held in anatomically correct position relative to each other.

29. A simulation manikin according to claim 1 wherein a sealable opening is defined in the first member or the second member through which liquid gelatine can be poured, optionally wherein the sealable opening is defined in the second member.

30. (canceled)

31. A simulation manikin according to claim 28 wherein a plug is provided for sealing the sealable opening.

32. A simulation manikin according to claim 1 wherein, in use, the tube and the simulated clavicle are placed in position on the first member, the first member and the second member are adjoined thereby providing a chamber between the first member and the second member, liquid gelatine is poured through the opening into the chamber defined between the first member and the second member, the liquid gelatine is cooled to set it in the chamber, after the gelatine has set, the first member and the second member are separated to reveal a first member having set gelatine formed thereon, wherein the gelatine has a surface which simulates the contours of half a neck to the clavicle and, within the set gelatine, the tube and simulated clavicle are in a position which is anatomically correct with respect to each other and the surface of the gelatine.

33. A simulation manikin according to claim 1 wherein the surface which simulates the contours of half a neck to the clavicle is lined with gauze.

34. A simulation manikin according to claim 1 wherein, gauze lines the outer surface of gelatine which sets in the chamber between the first member and the second member.

35. A simulation manikin according to claim 1 wherein, the manikin additionally comprises a second tube to simulate an artery, optionally wherein the second tube is removeably affixed to the first member and held in an anatomically correct position relative to the simulated clavicle and the first tube which simulates a vein.

36. (canceled)

37. A simulation manikin according to claim 35 wherein the second tube is manufactured of self-sealing material, optionally wherein the second tube is manufactured of rubber or polymer.

38. (canceled)

39. A simulation manikin according to claim 35 wherein the second tube has the shape and configuration of a human artery.

40. A simulation manikin according to claim 35 wherein the thickness of the second tube is anatomically correct relative to a human central artery.

41. A method for producing a manikin which comprises the steps of providing and assembling a first tube for simulating a vein, a simulated clavicle, a first member, a second member; pouring liquid gelatine into a chamber defined between the first member and the second member, cooling and setting the gelatine, separating the first member and the second member.

42. A method for teaching students central venous cannulation, wherein the method comprises the step of employing a manikin according to the invention.

43. (canceled)
